(19) United States
(12) Patent Application Publication
(10) Pub. No.: US 2009/0108037 A1
(43) Pub. Date: Apr. 30, 2009

(54) CARRYING ASSEMBLY FOR APPLIANCES AND DEVICES

(76) Inventor: Hans LIU, Rosemead, CA (US)

Correspondence Address: Steinfl & Bruno, 301 N Lake Ave Ste 810, Pasadena, CA, 91101, US

(21) Appl. No.: 11/932,926

(22) Filed: Oct. 31, 2007

(51) Int. Cl. A45F 5/02; F16C 11/00

(52) U.S. Cl. 224/199; 224/269; 403/24; 403/341

(57) ABSTRACT

A carrying assembly for devices, e.g. electronic devices, and appliances. The assembly is defined by a housing and engaging element (e.g., a button), a pin, and a carrying solution. The button has latching legs and defines a cavity. The pin is engageable with the button through insertion in the cavity. The carrying solution is a base element with a housing slot for the legs upon insertion of the button into the base element. Snapping engagement between the legs and housing slot and between the pin and the button occurs. The legs can be snappingly disengaged from the carrying solution. The pin can be rotationally disengaged from the button. The carrying assembly can be connected to a holster on one side and to a belt clip on the other side, forming an advantageous solution for the user.

### TECHNICAL FIELD

The present disclosure relates to a carrying assembly. In particular, it relates to a carrying assembly for appliances and devices, such as electronic appliances or devices. Specifically, the carrying assembly can be mounted on a carrying solution such as a housing or holster for appliances and devices, and is connectable with a clipping device, such as a belt clip.

### BACKGROUND

Electronic appliances or devices such as cellular phones, Blackberrys® and Personal Digital Assistants (PDAs) can be covered or protected with housings or cases. Those housings or cases are connected to a carrying solution or portion, that allows the devices to be carried by the user, e.g., detachably located on a belt.

In some instances, the carrying solution is connected to a button which, in turn, is connected to a belt clip. Button designs used on these carrying solutions for electronic devices are known in the art. The basic function of this known button design is to allow a carrying solution to snap and secure onto a removable belt clip which accommodates the button's size and shape.

Once attached to the belt clip, the button secures into the belt clip and prevents the carrying solution from falling off. The belt clip, in turn, secures the whole assembly (carrying solution carrying the device, button and belt clip) onto the belt of the end user.

Such design and similar designs have certain disadvantages so that alternative carrying solutions are desirable.

In particular, in some cases, the button is fixed to the carrying solution, i.e. it is not removable by the user. However, there is a certain group of customers that do not want the button to be fixed to the carrying solution and do not want the functionality of the button to be present in the carrying solution.

In some other designs, replaceable buttons are provided that require tools in order to be assembled, or are difficult to be assembled. In particular, the user is required to have some mechanical aptitude or certain skill level in handling tools, as well as being strong enough to secure the button.

In some cases, the existing designs are expensive, because several expensive materials are used and because complex injection molding techniques are required. In some of the existing designs, for example, a metal screw is embedded into a plastic button. The assembly process for such designs requires the metal part to be manually inserted into the tool cavity prior to each injection. Such required step slows down the tooling and also introduces unwanted reliability issues due to the presence of a manual process.

In some cases, the known assembly processes are not reliable and sometimes the buttons do not secure properly to the carrying solution, with the consequence that the button either becomes loose or breaks off.

In some cases, use of different materials in the same assembly can also create additional problems. For example, a metal screw has to be fixed to a belt clip and be inserted into a matching aperture of the carrying solution, the matching aperture usually made of plastic.

### SUMMARY

According to a first aspect of the present disclosure, a carrying assembly is provided, comprising a housing and engaging element, a pin and a base element. The housing and engaging element comprises one or more latching legs and defines a cavity. The pin is removably engageable with the housing and engaging element through insertion in the cavity. The base element comprises a housing slot, and is adapted to house at least a portion of the one or more latching legs of the housing and engaging element upon removable snapping engagement of the one or more latching legs with the housing slot.

According to a second aspect, a mechanical arrangement between a housing and engaging element and a pin is provided, the pin being detachably engageable with the housing and engaging element and disengageable therefrom. The mechanical arrangement comprises: a housing and engaging element and a pin. The housing and engaging element comprises a helicoidally shaped cavity, the cavity having a top aperture and a bottom aperture, the top aperture being larger than the bottom aperture. The pin comprises a top pin portion dimensionally substantially matching the top aperture of the cavity, a bottom pin portion dimensionally substantially matching the bottom aperture of the cavity, and helicoidally shaped walls substantially matching the helicoidally shaped cavity. In the mechanical arrangement, the helicoidally shaped cavity of the housing and engaging element and the helicoidally shaped walls of the pin are so shaped to allow rotational engagement of the pin with the housing and engaging element and rotational disengagement of the pin from the housing and engaging element.

Further embodiments of the present disclosure are provided in the claims, specification and drawings of the present writing.

The assembly of the present disclosure is intuitive to use and does not require the use of tools, although tools can be used to operate the assembly herein disclosed. In particular, readily available tools or household appliances can be used to remove the assembly, such as a coin or any basic flat head screwdriver. Also, although the assembly is intuitive to use, instructions can be provided to guide a user.

In some embodiments, the button of the present disclosure is removable from the base element or plate, thus being removable from the carrying solution. The button can be installed to and uninstalled from the carrying solution multiple times (at least 20 cycles). Further, the design of the button is such that the button can be accommodated to any carrying solution, such as a leather case, a holster, a shell, and so on.

Although the assembly can be made of one or more of any materials suitable to be used for manufacturing carrying solutions, including metal or other expensive material, advantageously, in one of the embodiments of the present application, all components of the assembly of the present disclosure are made of one material, in particular plastic, and can be injected at high speeds without the need to have additional parts to be inserted manually for proper operation.

Other advantages include the fact that, in some embodiments, no bulk is added to the carrying solution/belt clip combination used. Further, the design of the button is such that it passes the applicant's existing pull and shear test (20 lbs) for fixed buttons and the extended use test, which requires the button to stay secure in place and not slip for at least 1500 rotation cycles.

Further embodiments of the present disclosure are shown, in the specification, drawings and claims of the present application. Other features, objects, and advantages will be apparent from the description and drawings, and from the claims.

### BRIEF DESCRIPTION OF THE DRAWINGS

The accompanying drawings, which are incorporated into and constitute a part of this specification, illustrate one or more embodiments of the present disclosure and, together with the detailed description, serve to explain the principles and implementations of the disclosure.

In the drawings:

FIG. 1 is a top perspective view of a base element or plate in accordance with the present disclosure, adapted for attachment to a carrying solution for devices or appliances.

FIG. 2 is a side view of the base element.

FIG. 3 is a bottom view of the base element.

FIG. 4 is a top perspective view of a housing and engaging element according to an embodiment, the housing and engaging element adapted to be snapped in and snapped out of the base element of FIGS. 1-3.

FIG. 5 and its inset A show a side view of the housing and engaging element of FIG. 4.

FIG. 6 shows a bottom view of the housing and engaging element of FIGS. 4 and 5.

FIG. 7 shows a view from the top of the housing and engaging element of FIGS. 4-6.

FIG. 8 shows a top perspective view of a pin adapted for insertion into a cavity of the housing and engaging element of FIGS. 4-7.

FIG. 9 shows a side view of the pin of FIG. 8.

FIG. 10 is a sectional view of a detail of the bottom portion of the pin and the legs of a housing and engaging element according to an embodiment herein described when the housing and engaging element is inserted in the base element and the pin is inserted in the housing and engaging element.

FIG. 11 is an exploded perspective view showing the relative position of base element, housing and engaging element and pin according to an embodiment herein described for assembling purposes.

FIG. 12 is an exploded perspective view, showing connection of a housing and engaging element according to an embodiment herein described with the base element, before insertion of the pin.

FIG. 13 is a perspective view showing the completed assembly, where a housing and engaging element according to an embodiment herein described is snapped into the base element, and the pin is snapped into the button.

FIG. 14 shows the assembly according to an embodiment of the present disclosure (a) before and (b) after connection with a belt clip.

FIG. 15 shows the assembly according to an embodiment of the present disclosure mounted on a carrying solution, such as a housing or holster for a device or appliance, (a) during and (b) after attachment of the belt clip.

FIGS. 16-19 show a further embodiment of the assembly of the present disclosure.

FIG. 20 shows the assembly on FIGS. 16-19, (a) in an exploded view during attachment and (b) after attachment to a keychain-like device and to a carrying solution.

Like reference symbols in the various drawings indicate like elements.

### DETAILED DESCRIPTION

A carrying assembly is herein disclosed, the assembly comprising a housing and engaging element (e.g. a button), a pin and a base element.

In a preferred embodiment of the present disclosure, the assembly is made of homogeneous parts only and, in particular, of homogenous plastic parts only. In this way, a single tool can be used for injection purposes during the fabrication process, thus keeping costs down. In accordance with this preferred embodiment, no metal parts are necessary to strengthen the button to the carrying solution.

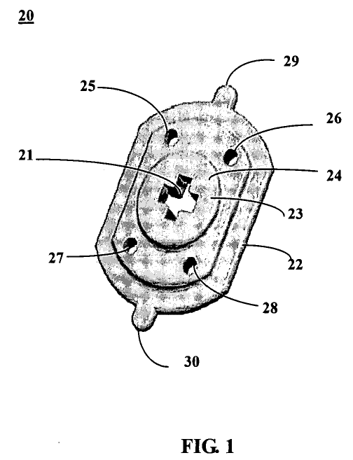

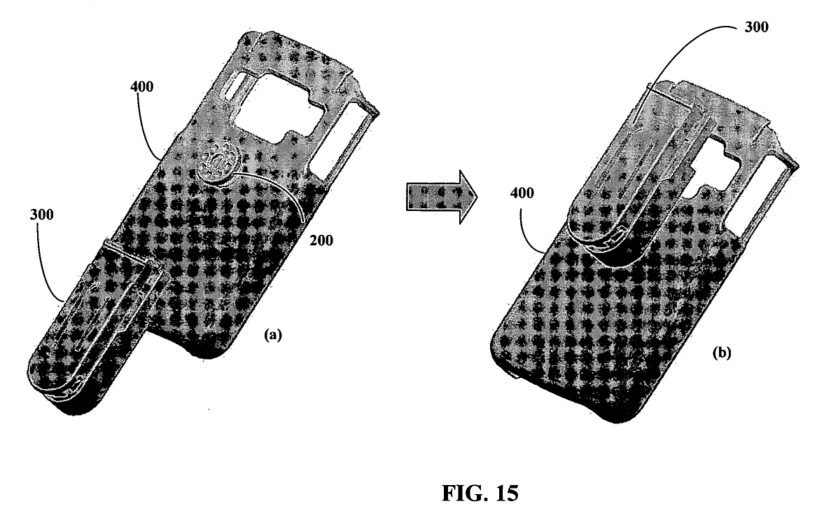

FIG. 1 is a top perspective view of a base element or plate (20) in accordance with the present disclosure. The terms “base element”, “plate”, “base plate” will be used interchangeably during the present disclosure. In its preferred use, the plate (20) is adapted to be connected to a carrying solution, such as a housing or holster carrying an appliance or device, as later shown in FIG. 15. Base element (20) contains and defines a cross-shaped slot, female element or feature (21), adapted to host or contain the legs or leg portions of the later described button, to allow latching or unlatching of the button. In the preferred embodiment of the present disclosure, latching of the button occurs through a rotational and/or snapping movement of the button into the base element (20), while unlatching of the button occurs through a rotational and/or snapping movement of the button out of the base element (20). Preferably, the dimension of cross (21) is such as being only as large as needed and not oversized. In particular, cross (21) exhibits proper clearance and tolerance to allow the legs of the button (later described) to snap in while preventing loose play of the legs due to excess slack.

The person skilled in the art will appreciate that snapping in to plate (20) and snapping out of plate (20) of the later described button will allow such button to be removable from the carrying solution hosting the plate (20).

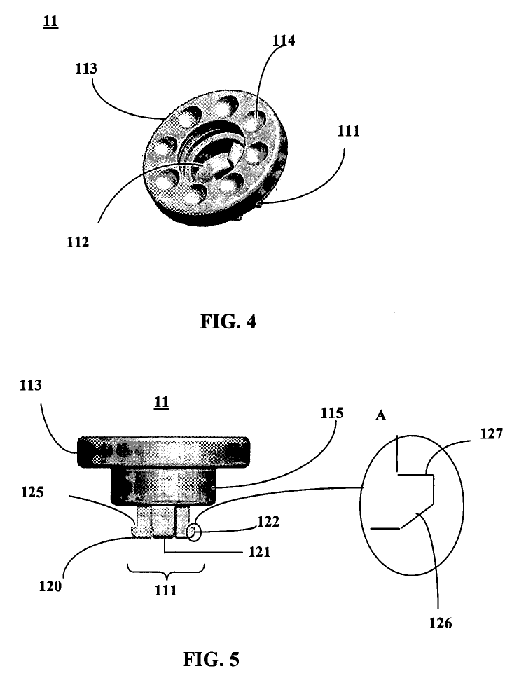

The cross shape of slot (21) FIG. 1 is particularly advantageous to allow the button (later shown in FIGS. 4-7) to be attached without having the button slip after repeated use and wear and tear. The person skilled in the art can also identify shapes that are different from a cross shape, such as an X-shape, a star shape or other similar shapes. In the embodiment shown in FIG. 1, base plate (20) is made of a three-layered structure (22, 23, 24) where top layer (24) is above intermediate layer (23), and intermediate layer (23) is above bottom layer (22). As shown in the figure, cross-shaped slot (21) goes across layers (22, 23, 24). Also shown in FIG. 1 are circular slots (25, 26, 27, 28) to allow the plate (20) to be fixed to a carrying solution, such as a case, housing or holster containing the appliance, e.g. an electronic appliance, of interest.

In a preferred embodiment of the present disclosure, base element (20) is stitched inside fabric or leather cases, to allow the assembly of the present disclosure to be used with fabric or leather carrying solutions for devices or appliances. Upper and lower protuberances (29, 30) of base element (20) can allow better attachment of the base element (20) to the carrying solution, and prevent slipping of the base element (20).

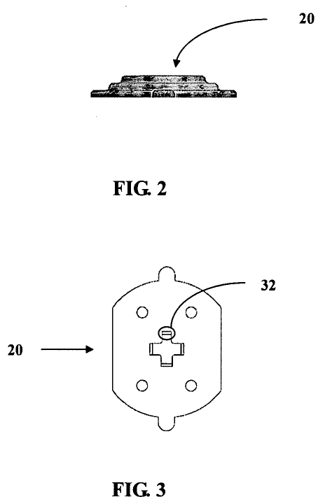

FIGS. 2 and 3 show a side view and a bottom view, respectively, of the base element of FIG. 1. In FIG. 3, element (32) is to show steps on each of the four sides of the back side of the slot (21), thus allowing the legs of the later described button to hook on to the slot (21).

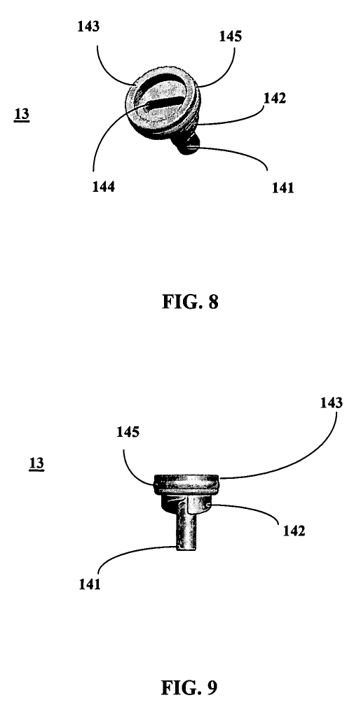

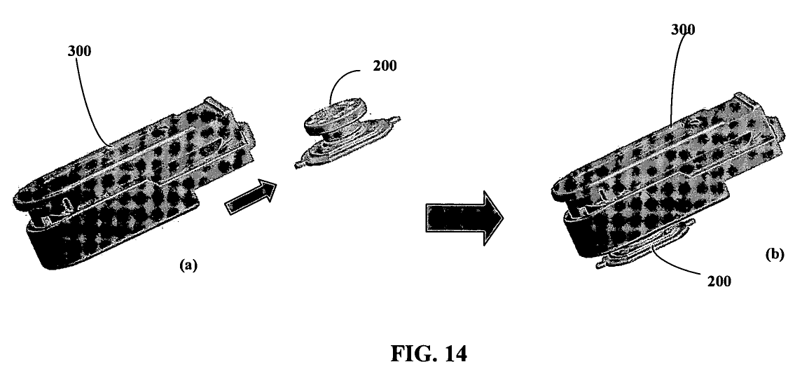

FIG. 4 is a top perspective view of a button (11) adapted to be snapped in and snapped from the base element (20) previously described in FIGS. 1-3, according to a mechanism to be later explained in detail. Shown in FIG. 4 is a top portion (113) of the button containing a plurality of depressed areas (114) having a circular profile. The depressed areas (114) are to provide a ratcheting feel when the button is rotating, e.g., under a belt clip, as later shown in FIG. 14. FIG. 4 also partially shows a plurality of latching legs (111), which will be better described in the subsequent FIG. 5. Finally, FIG. 4 briefly shows a cavity (112) adapted to allow introduction of a later described secure pin (13). As schematically indicated by reference numeral (112), the interior of the cavity can be elliptically shaped, to match with the later described pin walls (see subsequent FIGS. 8 and 9).

FIG. 5 shows a side view of button (11), where the top portion (113), an intermediate portion (115) and the plurality of latching legs (111) are shown. The legs (111) are here called “latching” legs because they will be latched in/latched out the base element (20). In the preferred embodiment there are four latching legs (111) having a bottom footprint substantially matching the cross shape of the slot (21) of the carrying solution (20). As also noted before, while a cross shape is shown in FIGS. 1 and 5, the person skilled in the art will understand that alternative leg/slot matching shapes are possible, e.g. an X-shape, a star shape and so on. By way of example and not of limitation, FIG. 5 shows three legs (120, 121, 122) of the preferred four legs.

The length of the legs (111) allows for a certain amount of flexibility to prevent premature mechanical fatigue and early mechanical failures. In particular, such length may depend on the specifications to be met, the load to be carried, and how wide the legs are. Such arrangement will allow for repeated insertions and removals of the button (11) from base plate (20). Additionally, the hook design (125) at the base of the legs is shaped to allow the legs (111) to be easily inserted into the hatch formed by slot (21) to cause the legs to flex back and allow them to snap into place.

In particular, the enlargement A of FIG. 5 shows a wall (126) that gives the legs an “inverse triangular” shape, with perpendicular surface latching. The inverse triangular shape (126) is advantageous because it allows the button (11) to be guided into the cross hatch (21) of base plate (20). Once the legs (111) snap in to place, the top surface (127) of each hook (125) will hook to the bottom surface of slot (21).

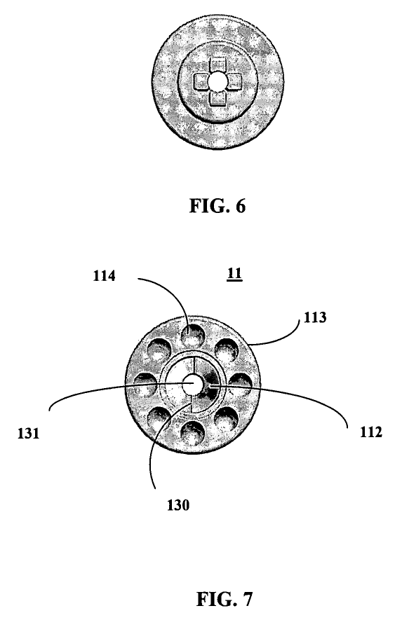

FIG. 6 shows a bottom view of the button (11).

FIG. 7 shows a view from the top of button (11), where the cavity (112), the top portion (113), the depressed areas (114) and the helical section (130) of the cavity (112) are shown. As also shown in FIG. 6, the bottom portion (131) of the button (11) is preferably open. A first reason to have the bottom portion (131) open and a void space provided above it is that a space is provided for the legs (111) to flex during insertion of the button (11) in the base plate (20). A second reason is to provide a cavity where secure pin (13) will be inserted. A third reason is that of allowing the button (11) to be properly shaped during fabrication.

FIG. 8 shows a top perspective view of a secure pin (13) adapted for insertion into the cavity (112) of the button (11). As shown in the figure, pin (13) comprises a top portion (143) and a pin portion (141). Top portion (143) contains a slotted cavity (144). Further, a helical wall (142) is located under the top portion (143) and around the pin portion (141). The helical wall (142) facilitates rotation of the pin (13) inside the helically shaped cavity (112) of the button (11) during insertion of the pin (13) into the button (11) or extraction of the pin (13) from the button (11), in combination with the slotted cavity (144). Insertion of the pin (13) into cavity (112) can occur through a combined rotational and snapping movement, while extraction of the pin (13) from cavity (112) can occur with a rotational movement, e.g., counterclockwise. Rotational insertion or extraction of the pin (13) is obtained through the shaping of the helical wall (142). In particular, the slanting angle of the helical shape is designed to obtain the desired movement.

During insertion of the pin (13), the helical wall (142) interacts with the helical contour of the cavity (112) of button (11) and rotates the pin (13), allowing the pin (13) to be inserted all the way down to the proper position. During insertion of the pin (13) into button (11), the helical shape of the walls of the pin (13) and the helical shape of the cavity (112) come into contact and force the pin (13) to rotate until the button (11) is fixed in place.

As the two helical shapes are in contact to each other and there is a force downward on the pin (13) to push it down, the pin (13) will slide and twist. Such rotation is obtained through interaction of the two helical features and is not induced by a rotational movement of the user. The pin (13) will slip and twist until the two features have no interference with each other.

As shown in FIG. 8 (and later in FIG. 9), the pin (13) also includes a circularly shaped protruding portion (145). Such portion helps snapping of the pin (13) into cavity (112) of button (11), thus securing the pin (13) in a down position and preventing the pin (13) from falling out the button (11). To remove the pin (13), a counterclockwise turn will cause the helical wall (142) of pin (13) and the helical shape of the cavity (112) of button (11) to overlap and push the pin (13) out by exertion of enough rotational force to overcome the hold of portion (145). The design of the pin (13), is such that the pin (13) cannot be pushed too far or overexert pressure that could cause damage or premature failure of the pin (13).

Therefore, the person skilled in the art will understand that, in a preferred embodiment of the present disclosure, insertion of the pin (13) into the button (11) occurs through a combined rotational and snapping movement, and similarly, extraction of the pin (13) from the button (11) occurs through a combined un-snapping and rotational movement in the other direction.

The slotted cavity (144) of FIG. 8 is similar to the cavity usually present on screws. The cavity (144) allows a flat tipped tool to unscrew the secure pin (13). If desired, arrows can be put above and below the cavity to show the direction of rotation of the pin (13). The cavity (144) is preferably designed to be slightly wider than norm to allow for typical household items, such as knives or safety pins, to fit into them.

FIG. 9 shows a side view of the pin (13), where top portion (143), protruding portion (145), helical wall (142) and pin portion (141) are shown. When assembled, the pin portion (141) acts as a reinforcing wall to the legs (111).

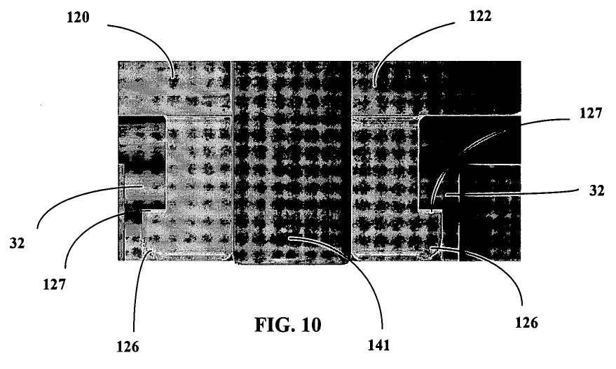

FIG. 10 is a sectional view of a detail of the bottom portion (141) of the pin and the legs (111) of the button (11) when the button (11) is inserted in the base element (20) and the pin (13) is inserted in the button (11). In particular, FIG. 10 shows latching cooperation between the stepped bottom surface (32) of the base element (20) and the side surface (126) having, in the embodiment shown in the figure, a rounded surface.

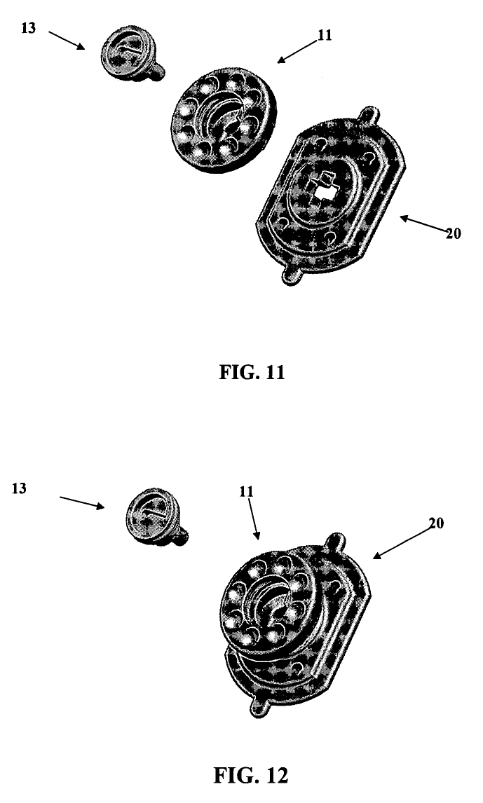

FIG. 11 is a first exploded perspective view, showing the relative position of base element (20), button (11) and pin (13) for assembling purposes.

FIG. 12 is a second exploded perspective view, showing connection of button (11) with base element (20).

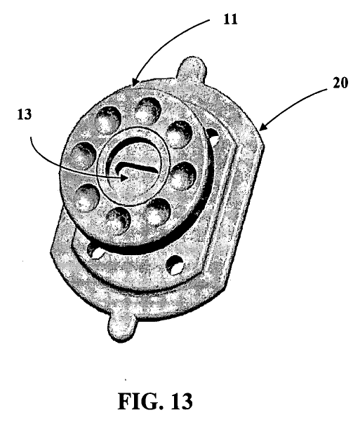

FIG. 13 is a perspective view showing the completed assembly, where button (11) is connected to base element (20), and pin (13) is snapped into button (11).

During assembly between button (11) and base element (20), the legs (111) are inserted into slot (21). Advantageously, the presence of pin portion (121) prevents the legs (111) from springing back and the button (11) from snapping out. In particular, once the pin (13) is inserted, it acts as a support or wall behind the legs (111). This prevents the legs from springing back, thus making the whole assembly rigid. As a consequence, the pin (13) also acts as a support wall to increase the strength of the whole assembly, so that the product can meet shear and pull testing requirements.

In view of what described above, the person skilled in the art will understand that the assembly of the present disclosure is formed by: 1) providing a base element, a button and a pin; 2) inserting the button in the base element through a snapping movement; and 3) inserting the pin into the button through a combined rotational and snapping movement, the pin allowing—once inserted—reinforcement of the engagement between the base element and the button. Portions of the assembly formed as above are also easily removable: 1) the pin is extracted from the button through a rotational movement; and 2) the button is extracted from the base element through an unsnapping movement, thus accomplishing the desired removability of the button from the carrying solution.

FIG. 14 shows the assembly (200) of the present disclosure (a) before and (b) after connection with a belt clip (300).

FIG. 15 shows the assembly (200) of the present disclosure mounted on a carrying solution, such as a housing or holster (400) for a device or appliance, (a) during and (b) after attachment of the belt clip (300).

Although FIGS. 1 to 15 describe assembly wherein the housing and engaging element is a button, further embodiments are also herein disclosed wherein a more generic housing and engaging element is included in place of a button.

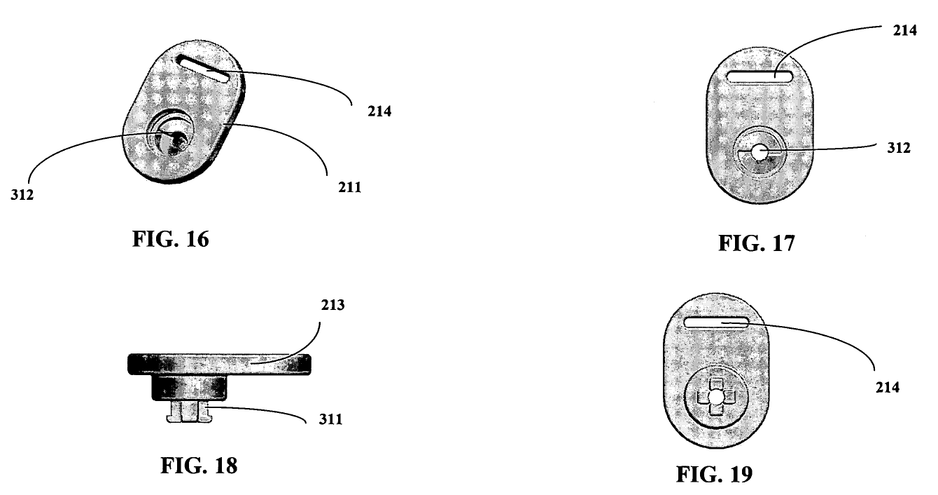

FIGS. 16-19 show an exemplary further embodiment of the assembly of the present disclosure, where a housing an engaging element (211) is to replace the button (11) shown, for example, in FIG. 4. As shown in FIGS. 16-19, similarly to button (11), the housing and engaging element (211) is adapted to be snapped in and snapped from the base element (20) described so far with reference to the previous figures. As shown for example in FIG. 18, the element (211) comprises a top portion (213). As shown in FIGS. 16, 17 and 19, top portion (213) can contain and define a slot (214), which is provided to allow attachment of the carrying assembly to an element such as a keychain-like element. Similarly to the button embodiment, housing/engaging element (211) comprises a plurality of latching legs (311) and a cavity (312), the cavity being adapted to allow introduction of a pin such as pin (13). Also in this embodiment, the interior of the cavity (312) can be elliptically shaped. The person skilled in the art will understand that all details and shapes discussed with reference to the button embodiment can also be easily applied to the housing/engaging element embodiment. Additional, housing and engaging elements are identifiable by a skilled person upon reading of the present disclosure will not herein described in further details.

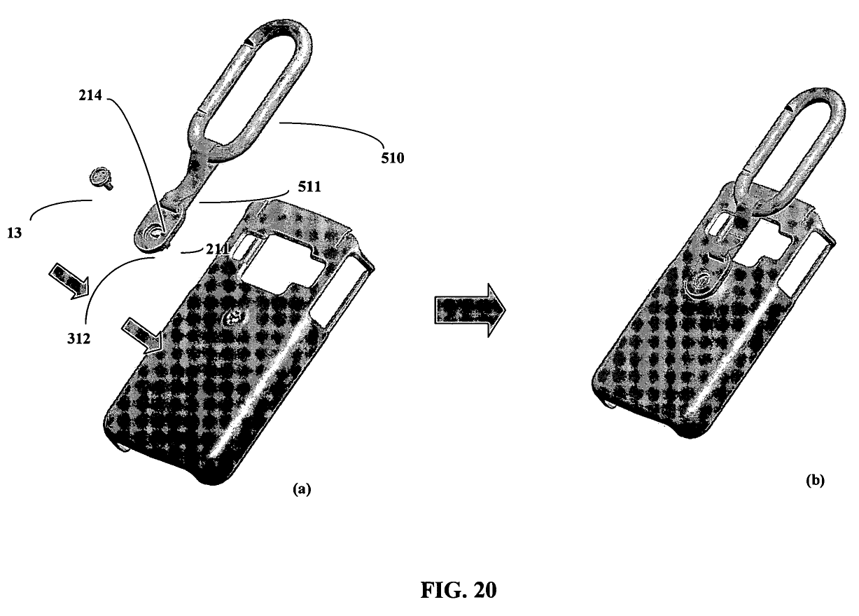

FIG. 20 shows the assembly of FIGS. 16-19 in two different conditions. In a first condition, depicted in FIG. 20(a), the assembly is shown in an exploded view together with a pin (13) to be inserted into cavity (312) and a keychain-like element (510) connected to the housing/engaging element (211) through a hooking element (511) passing through slot (214). FIG. 20(b) show the assembly after attachment to the carrying solution.

In summary, according to some embodiments of the present disclosure, a carrying assembly for devices, e.g. electronic devices, and appliances is provided. The assembly is defined by a housing and engaging element such as button, a pin, and a carrying solution. The button has latching legs and defines a cavity. The pin is engageable with the button through insertion in the cavity. The carrying solution is a base element with a housing slot for the legs upon insertion of the button into the base element. Snapping engagement between the legs and housing slot and between the pin and the button occurs. The legs can be snappingly disengaged from the carrying solution. The pin can be rotationally disengaged from the button. The carrying assembly can be connected to a holster on one side and to a belt clip on the other side, forming an advantageous solution for the user.

It is to be understood that the disclosure is not limited to particular configurations or the assembly, components or devices, which can, of course, vary. It is also to be understood that the terminology used herein is for the purpose of describing particular embodiments only, and is not intended to be limiting. As used in this specification and the appended claims, the singular forms “a,” “an,” and “the” include plural referents unless the content clearly dictates otherwise. Unless defined otherwise, all technical and scientific terms used herein have the same meaning as commonly understood by one of ordinary skill in the art to which the disclosure pertains.

The description set forth above is provided to give those of ordinary skill in the art a complete disclosure and description of how to make and use the embodiments of the assembly, components, devices, systems and methods of the disclosure, and are not intended to limit the scope of the disclosure. Although any methods and materials similar or equivalent to those described herein can be used in the practice for testing of the assembly, components, device(s) and methods herein disclosed, specific examples of appropriate materials and methods are described herein.

Modifications of the above-described modes for carrying out the device(s) and methods herein disclosed that are obvious to persons of skill in the art are intended to be within the scope of the following claims. All patents and publications mentioned in the specification are indicative of the levels of skill of those skilled in the art to which the disclosure pertains. All references cited in this disclosure are incorporated by reference to the same extent as if each reference had been incorporated by reference in its entirety individually.

A number of embodiments of the device(s) and methods herein disclosed have been described. Nevertheless, it will be understood that various modifications may be made without departing from the spirit and scope of the disclosure. Accordingly, other embodiments are within the scope of the following claims.

What is claimed is:

1. A carrying assembly comprising:
a housing and engaging element comprising one or more latching legs and defining a cavity;
a pin, removably engageable with the housing and engaging element through insertion in the cavity; and
a base element comprising a housing slot, the base element adapted to house at least a portion of the one or more latching legs of the housing and engaging element upon removable snapping engagement of the one or more latching legs with the housing slot.

2. The carrying assembly of claim 1, wherein the one or more legs define a bottom shape of the housing and engaging element substantially matching the shape of the housing slot.

3. The carrying assembly of claim 1, wherein, in a condition where the housing and engaging element is snapped into the base element and the pin is inserted into the cavity, a bottom portion of the pin acts as a reinforcing wall for the one or more latching legs to keep the one or more latching legs in contact with the base element.

4. The carrying assembly of claim 1, wherein the one or more latching legs comprise a hook portion to ease insertion of the one or more latching legs into the housing slot of the base element.

5. The carrying assembly of claim 4, wherein the hook portion comprises a side surface having an inverse triangular shape.

6. The carrying assembly of claim 4, wherein the hook portion comprises a side surface having a rounded shape.

7. The carrying assembly of claim 1, wherein the cavity of the housing and engaging element has helicoidally shaped cavity walls and the pin comprises helicoidally shaped pin walls to allow rotational insertion of the pin into the housing and engaging element upon engagement of the pin with the housing and engaging element and rotational extraction of the pin from the housing and engaging element upon disengagement of the pin from the housing and engaging element.

8. The carrying assembly of claim 1, wherein the pin is both engageable with the housing and engaging element and disengageable from the housing and engaging element, and wherein engagement occurs through a snapping insertion of the pin into the cavity of the housing and engaging element and disengagement occurs through rotational extraction of the pin from the cavity of the housing and engaging element.

9. The carrying assembly of claim 8, wherein the pin comprises a protruding portion to facilitate keeping in place of the pin upon the snapping vertical insertion of the pin into the cavity of the housing and engaging element.

10. The carrying assembly of claim 8, wherein the pin comprises a slotted cavity to facilitate the rotational extraction of the pin from the cavity of the housing and engaging element.

11. The carrying assembly of claim 1, wherein housing and engaging element is a button, the button including a top portion encircling the cavity, the top portion comprising a plurality of depressed areas.

12. The carrying assembly of claim 1, wherein the housing and engaging element includes a top portion and an intermediate portion separating the top portion from the one or more latching legs.

13. The carrying assembly of claim 1, wherein the housing slot of the base element is cross shaped.

14. The housing assembly of claim 1, wherein the housing slot comprises a stepped bottom surface.

15. The carrying assembly of claim 1, wherein the housing and engaging element, the pin, and the base element are made of plastic.

16. A housing for a device or an appliance, the housing comprising the carrying assembly of claim 1.

17. A carrying arrangement for a device or an appliance, the carrying arrangement comprising a belt clip and the housing of claim 16, the belt clip being detachably connected to the housing.

18. A mechanical arrangement between a housing and engaging element and a pin, the pin being detachably engageable with the housing and engaging element and disengageable therefrom, comprising:
a housing and engaging element comprising a helicoidally shaped cavity, the cavity having a top aperture and a bottom aperture, the top aperture being larger than the bottom aperture; and
a pin comprising: a top pin portion dimensionally substantially matching the top aperture of the cavity, a bottom pin portion dimensionally substantially matching the bottom aperture of the cavity, and helicoidally shaped walls substantially matching the helicoidally shaped cavity,
wherein the helicoidally shaped cavity of the housing and engaging element and the helicoidally shaped walls of the pin are so shaped to allow rotational engagement of the pin with the housing and engaging element and rotational disengagement of the pin from the housing and engaging element.

19. The mechanical arrangement of claim 18, wherein the pin comprises a protruding pin portion located between the top pin portion and the bottom pin portion to allow latching engagement of the pin with the housing and engaging element.

20. The mechanical arrangement of claim 18, wherein the pin comprises a slotted cavity to facilitate the rotational disengagement of the pin from the housing and engaging element.

21. The mechanical arrangement of claim 18, wherein the housing and engaging element comprises a bottom latching portion surrounding the cavity, to allow latching of the housing and engaging element with a separate mechanical component.

22. The mechanical arrangement of claim 21, wherein the bottom pin portion interacts with the bottom aperture of the housing and engaging element to cooperate with the bottom latching portion of the housing and engaging element during latching with the separate mechanical component.

23. The mechanical arrangement of claim 18, wherein the housing and engaging element is a button.
